(19) United States
(12) Patent Application Publication
(10) Pub. No.: US 2006/0219422 A1
(43) Pub. Date: Oct. 5, 2006

(54) Electrical box with rotation ring

(76) Inventors: Bogdan Safiejko, Wildwood, IL (US); John Lucas Safiejko, Wildwood, IL (US)

Correspondence Address: BOGDAN SAFIEJKO, 17672 W. WARREN AVE., WILDWOOD, IL, 60030, US

(21) Appl. No.: 11/095,787

(22) Filed: Mar. 31, 2005

(51) Int. Cl. H01H 13/04

(52) U.S. Cl. 174/58

(57) ABSTRACT

An electrical box with a covering plate that is able to move 7/16″ in any direcion. The plate has a box that you can fasten light switches and etc. to. To move the plate around you must loosen the screws on the washy then move it around, and as a reference point you can use the three brackets to center the plate on the box and when it is in its desired position you must tighten them to the electrical box. The electrical box has two brackets of which you can fasten it to the g. The electrical box has many potential access points for electrical conduit etc. This invention allows people to move the plate instead of moving the entire box

We, Bogdan Safiejko and Luke Safiejko, and our citizenship is with the United States of America, have invented a new utility, as set forth in the following specification. This is an electrical box with a rotation ring, which you can put a double switch or double outlet. The invention is designed to minimize the risk of a bad installation, for example if the electrical box is installed wrong it can be moved 7/16″ in any direction into the correct position, with the adjustable plate, within 5 minutes with minimum damage to the walls or ceiling surfaces. The rotation of this plate can be increased from 7/16″ to an infinite measurement. Most of the problems are around the woodwork and ceramic tile. Instead of the alternative which involves smashing out the wall and moving all the electrical pipes which would take an estimated 2-3 hours, and it would cost a lot more than just putting in this box, and that's not even talking about time delays. My idea can be used for any traditional electrical boxes, (single switch or outlet, double switch, triple switch, quadruple switch box, ceiling box). Application Ser. No. 11/095,787

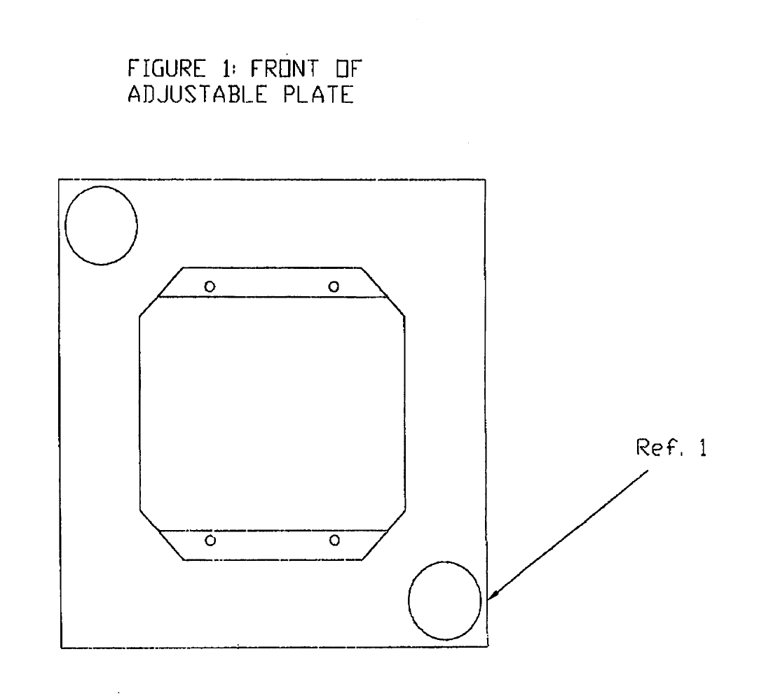

FIG. 1 is the front view of the mounting box, with mounting brackets and supports for the adjustable plate.

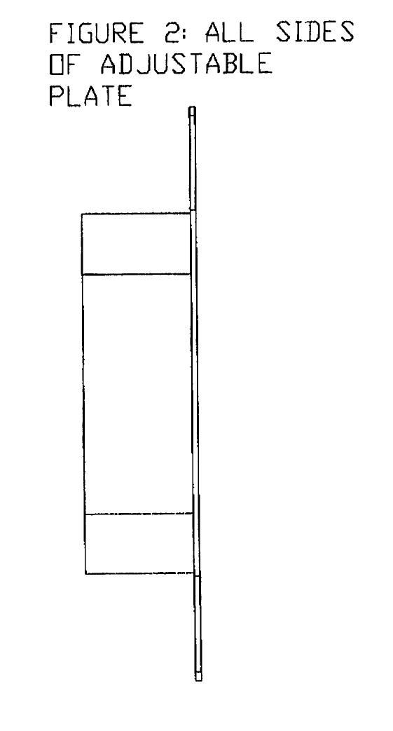

FIG. 2 is the rear view of the mounting box.

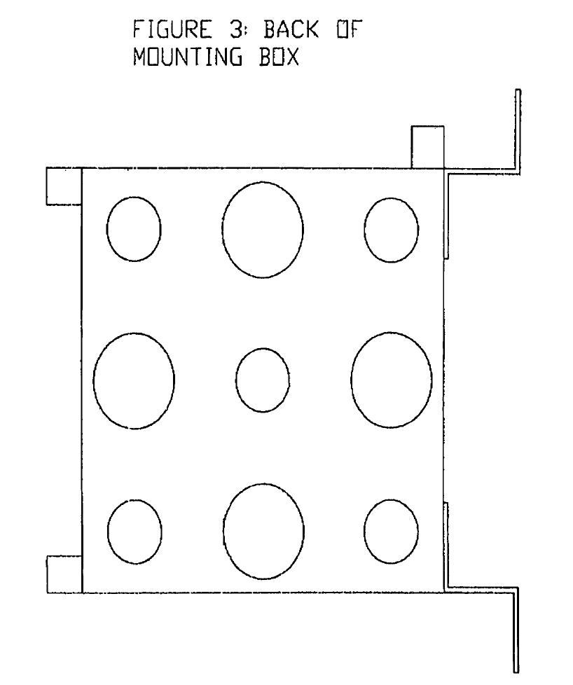

FIG. 3 is the top and bottom view of the mounting box showing entry points for the electrical pipes.

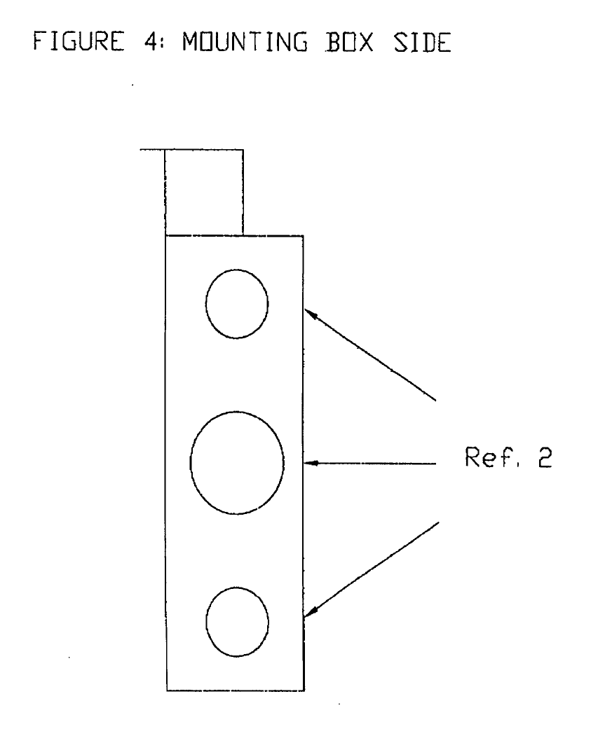

FIG. 4 is the left view of the mounting box, it is the right view also if mirrored, and also showing entry points for the electrical pipes.

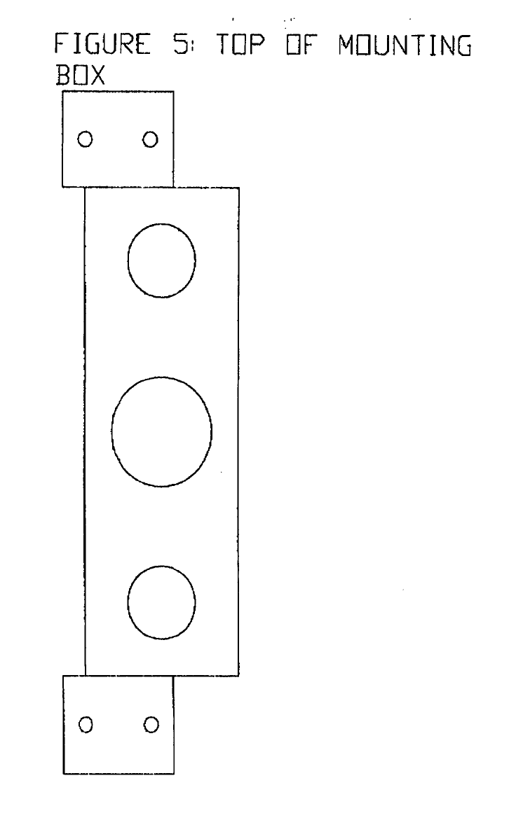

FIG. 5 is the front and rear view of the adjustable plate showing mounting holes for outlets etc. and also showing holes for the actual adjusting of the plate

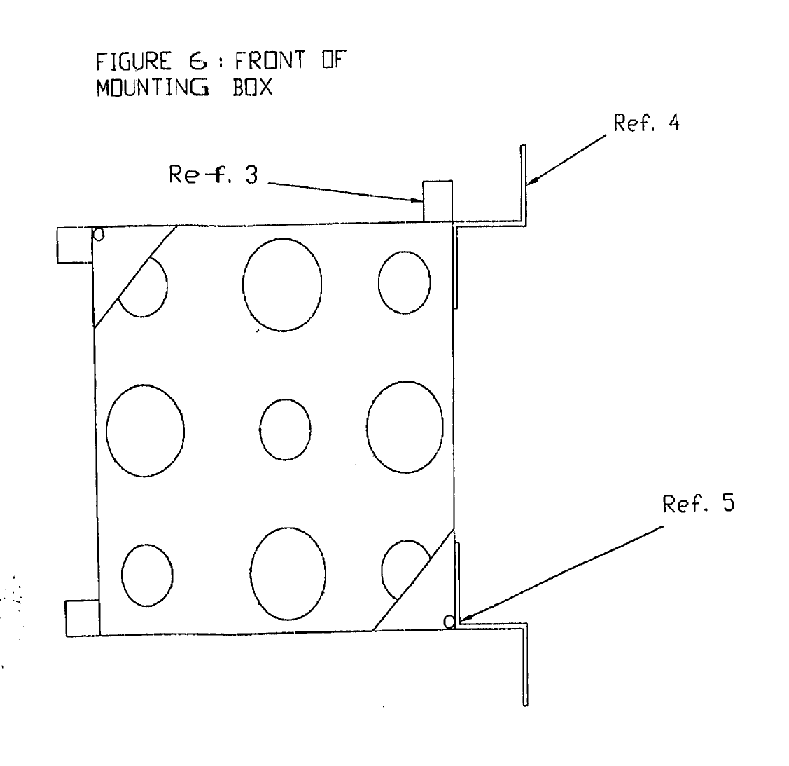

FIG. 6 is the top, bottom, and left and right side views of the adjustable plate.

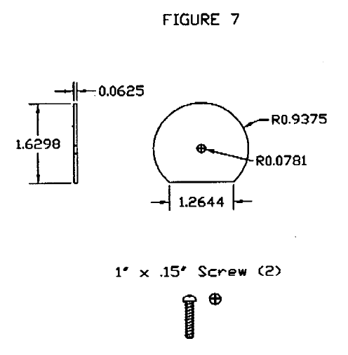

FIG. 7 is the front, rear and side views of the washers used for the adjusting and tightening of the plate to the box. The screws that are shown, are used to tighten the plate to the box,

1. I claim: the functionality of the adjustable plate, which can be moved in any direction within 7/16″, and also the mounting box, which the plate is secured to.
